(19) United States
(12) Patent Application Publication
(10) Pub. No.: US 2026/0042434 A1
(43) Pub. Date: Feb. 12, 2026

(54) ELECTROMECHANICAL BRAKE SYSTEM WITH PNEUMATIC TRAILER ACTUATION

(71) Applicant: ZF CV Systems Global GmbH, Bern (CH)

(72) Inventor: Julian Van Thiel, Grossburgwedel (DE)

(21) Appl. No.: 19/101,080

(22) PCT Filed: Aug. 5, 2022
(86) PCT No.: PCT/EP2022/072067

§ 371 Date: Feb. 4, 2025

(51) Int. Cl. B60T 13/68; B60T 13/26

(52) U.S. Cl. CPC B60T 13/683; B60T 13/263; B60T 2270/413

(57) ABSTRACT

A pneumatic trailer valve arrangement (1) for an electromechanical brake system (202) includes a trailer control valve (10) having a supply connector (11), a trailer supply connector (12) for providing supply pressure (pV) for a trailer, a trailer brake pressure connector (14) for providing a trailer brake pressure (pBA), an electromagnetic pilot control unit (110) which, as a function of the trailer switching signals (S1, S2, S3) received at the trailer control valve (10), sets the trailer brake pressure (pBA) at the trailer brake pressure connector (12), and a pneumatic redundancy connector (16) for receiving a redundancy pressure (pR). The trailer control valve (10) sets the trailer brake pressure (pBA) redundantly based on the redundancy pressure (pR). A redundancy valve unit (20) for providing the redundancy pressure (pR) provides the redundancy pressure (pR) at a redundancy output (22) based on received redundancy switching signals (SR1, SR2).

### FIELD

The present disclosure relates to a pneumatic trailer valve arrangement for a brake system, in particular an electromechanical brake system, which includes a trailer control valve of pneumatic design. The present disclosure further relates to an electromechanical brake system for a commercial vehicle, having a pneumatic trailer valve arrangement, to a commercial vehicle and to a method.

### BACKGROUND

Brake systems, such as those used for commercial vehicles, are usually pneumatic brake systems that operate with compressed air. This applies to both tractive units and trailers, whereby one or a plurality of compressed air circuits are provided in the tractive unit and the brake system of the tractive unit has valves to provide compressed air in a targeted manner for pneumatically activatable brake actuators on the wheels, in order to cause a deceleration of the tractive unit. Trailers for such commercial vehicles also comprise a pneumatic brake system, but are supplied from an air treatment unit in the tractive unit. For this purpose, both the tractive unit and the trailer are equipped with two pneumatic connections, namely a “supply” coupling head and a “brake” coupling head. Supply pressure is supplied from the tractive unit to the trailer vehicle via the “supply” coupling head and then used in the trailer to top up a trailer supply provided for this purpose. On the other hand, a control pressure which indicates the level of brake pressure for the trailer is transmitted via the “brake” coupling head.

With increasing electrification in the automotive sector, the brake system of tractive units is also increasingly electrified. For this reason, electromechanical brake systems have been developed and used more frequently in recent years, which no longer work with compressed air in the tractive unit, but instead actuate electric brake actuators and in which the deceleration of the tractive unit is implemented by electromechanical actuators.

However, there is an ongoing requirement for towing trailers that have a conventional pneumatic brake system using electrified tractive units, and for actuating the pneumatic brake system of the trailer.

A trailer control valve for this purpose is known from EP 3 822 133 A1. The trailer control valve comprises at least two electrical connectors which are designed to receive two independent but redundant electrical control signals which have the signal for a pre-set brake control pressure, at least one valve which is designed to set a constant air pressure of an air pressure source to the pre-set brake control pressure, a brake supply pressure connector which is a pneumatic outlet and is designed to provide the pre-set brake supply pressure to the pneumatic trailer brake system, a brake control pressure connector which is a second pneumatic outlet and is designed to provide the pre-set brake control pressure to the pneumatic brake system of the trailer, wherein the compressed air source is disposed within the trailer control valve.

Furthermore, a trailer control module is known from EP 3 822 134 B1, which is provided for a brake system of a motor vehicle with a trailer, the latter comprising a pneumatic brake system which is conceived to provide the pneumatic brake system of the trailer with a pre-set brake control output pressure. The trailer control module according to this disclosure comprises at least two electrical connectors which are conceived to receive two independent but redundant electrical control input signals comprising the signal for a pre-set brake control output pressure, at least one air pressure source input which is conceived to receive compressed air from a compressed air source, at least one valve which is conceived to adjust the constant air pressure from the air pressure source to the pre-set brake output pressure, at least one brake supply pressure connector which is conceived to provide the brake supply output pressure to the trailer pneumatic brake system, and at least one brake control pressure connector which is conceived to provide the pre-set brake control output pressure to the trailer pneumatic brake system. The trailer control module is distinguished in that it comprises at least two control solenoid groups, each of which comprises at least one load valve and at least one outlet valve, and forms a part of the control channel.

While both solutions do work, further improvements are needed, especially in terms of installation space and a reduction in the number of individual components.

### SUMMARY

The object is achieved by the present disclosure in a first aspect by a pneumatic trailer valve arrangement for a brake system, in particular an electromechanical brake system, including a trailer control valve having a supply connector for receiving supply pressure, a trailer supply connector for providing supply pressure for a trailer, a trailer brake pressure connector for providing a trailer brake pressure for the trailer, an electromagnetic pilot control unit which, as a function of trailer switching signals received at the trailer control valve, is designed to set the trailer brake pressure at the trailer brake pressure connector, and having a pneumatic redundancy connector for receiving a redundancy pressure, wherein the trailer control valve, as a function of the trailer switching signals, is designed to set the trailer brake pressure redundantly as a function of the redundancy pressure at the trailer brake pressure connector. Furthermore, the pneumatic trailer valve arrangement includes a redundancy valve unit having a supply connector for receiving supply pressure and a redundancy output for providing the redundancy pressure, wherein the redundancy valve unit is designed to provide the redundancy pressure at the redundancy output as a function of the redundancy switching signals received at the redundancy valve unit.

The present disclosure is based on the finding that a conventional trailer control valve can also be provided in an electromechanical brake system for an electromechanically braked commercial vehicle, if the corresponding components are also provided for redundancy. According to the present disclosure, the redundancy valve unit is provided for this purpose, which for redundancy, specifically when trailer switching signals cannot be provided or cannot be provided correctly, delivers the redundancy pressure and provides the latter at the trailer control valve. Both the trailer control valve and the redundancy valve unit are supplied with supply pressure and have a supply connector for this purpose. The appropriate reservoir or compressor can be connected to both supply connectors, the supply connector of the trailer control valve, and the supply connector of the redundancy valve unit. In this respect, these two units can receive the same supply pressure. It may also be provided that the trailer control valve and the redundancy valve unit are each assigned a dedicated compressed air supply, a dedicated compressor or a dedicated air treatment unit. The redundancy valve unit is dedicated only to the trailer control valve, and the redundancy output of the redundancy valve unit is connected exclusively to the trailer control valve, more specifically to the pneumatic redundancy connector of the trailer control valve. In normal operation, the trailer control valve can receive the corresponding trailer switching signals from a superordinate control unit such as, for example, a central control unit of the electromechanical brake system, or else directly from an electric brake value transducer such as, for example, an electric brake pedal. The superordinate control unit such as, for example, the central control unit, can also be connected to a unit for autonomous driving and receive from the latter braking request signals, trajectory planning data and the like. As a function thereof, the superordinate control unit such as, for example, the central control unit, can then provide the trailer switching signals to the trailer control valve. The redundancy valve unit can likewise receive the redundancy switching signals from a superordinate control unit such as, for example, the central control unit, or another redundant control unit. The redundancy valve unit can also receive the redundancy switching signals from an electric brake value transducer such as, for example, an electric brake pedal. In one variant, the redundancy switching signals are identical or analogous, or are generated and provided as a function of the trailer switching signals.

In a first preferred embodiment, the redundancy connector of the trailer control valve is connected to the pilot control unit of the trailer control valve. The trailer control valve also preferably includes a main valve unit, and the pilot control unit provides a first control pressure at the main valve unit, the latter then boosting the first control pressure and setting it as trailer brake pressure at the trailer brake pressure connector. By connecting the redundancy connector to the pilot control unit, it is sufficient that the redundancy pressure is a low control pressure which can then be boosted by the main valve unit of the trailer control valve. It is not necessary that the redundancy pressure itself is already a high working pressure which can then be used directly to aerate pneumatic brake actuators.

In a further preferred design embodiment, the trailer control valve has a redundancy check valve for blocking the redundancy connector. The redundancy check valve preferably blocks the redundancy connector in an energized position and releases the redundancy connector when de-energized. It can be ensured as a result that the redundancy pressure cannot be provided by energizing the redundancy check valve in order to prevent the redundancy pressure from being unintentionally released. In the event that the trailer control valve is de-energized, the redundancy check valve is preferably opened so that the redundancy pressure can be set. In a preferred refinement, the trailer switching signals and the redundancy switching signals are provided by two independent and functionally at least partially redundant electrical control units. For example, the trailer switching signals are provided by a primary central control unit, and the redundancy switching signals are provided by a secondary central control unit which functionally at least partially substitutes for the primary central control unit. It can also be provided that the primary and the secondary central control unit each provide both the trailer switching signals and the redundancy switching signals to enable a further level of redundancy.

In one variant, the redundancy valve unit has a redundancy valve unit housing and can be installed as an independent module in the brake system. This allows the two units to be disposed separately from one another in the brake system, as a result of which the footprint of the apparatuses can be reduced. In addition, it is possible to use and insert the redundancy valve unit as a retrofit part in conjunction with a conventionally designed trailer control valve. It can be provided that the redundancy valve unit, conjointly with its redundancy valve unit housing, is directly flanged to the trailer control valve in order to represent this as a modular entity.

In a further preferred embodiment, it can be provided that the redundancy valve unit is integrated in another functional module of the brake system. In this variant, it is not necessary that the redundancy valve unit has its own redundancy valve unit housing; rather, it is preferred that the redundancy valve unit, i.e. the functional elements thereof, are integrated in a further functional module. The further functional module is preferably a primary brake control unit, secondary brake control unit, or air treatment unit. It can also be provided that the redundancy valve unit is integrated in a parking brake valve unit or the trailer control valve. It can also be provided that the redundancy valve unit is integrated in a steering, a transmission, a brake pedal, or other units such as, for example, a battery control unit.

According to a further preferred embodiment, the redundancy valve unit has an electromagnetic redundancy pilot control unit and a redundancy main valve unit, wherein the redundancy pilot control unit sets a redundancy control pressure at the redundancy main valve unit as a function of the redundancy switching signals, and the redundancy main valve unit sets a redundancy pressure as a function of the redundancy control pressure. The redundancy main valve unit preferably boosts the redundancy control pressure and then sets the latter. As a result, the air consumption can be reduced, which is particularly preferred in the use according to the present disclosure in the context of the electromechanical brake system, because electromechanical brake systems typically have smaller compressed air reservoirs or smaller air treatment units, because these are provided only in the event that the tractive unit is to be used to tow a non-electrified trailer. This variant can also reduce the footprint of the individual modules, thereby reducing the overall installation space.

Furthermore, it is preferred that the redundancy pilot control unit has an inlet valve and an outlet valve, wherein the inlet valve is connected to the supply connector, receives a supply pressure and is able to be switched by a first redundancy switching signal for setting the redundancy control pressure at the redundancy main valve unit, and wherein the outlet valve is connected to a bleeding unit and is able to be switched by a second redundancy signal for bleeding the redundancy control pressure. The inlet valve and the outlet valve are preferably each designed as monostable 2/2-way valves. However, a 3/2-way valve can also be used instead, which then acts as a combined inlet/outlet valve. Preferably, the inlet valve is closed when de-energized, and the outlet valve is open when de-energized. It can be ensured in this way that no brake pressure is set in the de-energized state. The redundancy main valve unit preferably includes a redundancy relay valve having a pneumatic control connector, at which the redundancy control pressure is set. The redundancy relay valve boosts the redundancy control pressure and provides the boosted redundancy control pressure at the redundancy output.

In a further preferred embodiment, the redundancy valve unit includes a bistable function so that a set redundancy pressure can remain set even if the redundancy switching signals are absent. In one variant, the redundancy valve unit includes an electromagnetic bistable valve that provides the bistable function. For example, an electromagnetic bistable valve can have two magnetic latching positions which are defined by two end magnets. Such an electromagnetic bistable valve always remains in one of the two end positions, even when de-energized.

In another variant, the redundancy valve unit can include pneumatic self-locking that provides the bistable function. Bistability can also be achieved purely pneumatically by correspondingly interconnected valves, as is known in principle. Even if the corresponding control pressure for switching the valve is absent, the valve position can then be maintained, in particular by pneumatic self-locking.

In a second aspect, the object mentioned at the outset is achieved by an electromechanical brake system for a commercial vehicle, having a primary brake control unit and a secondary brake control unit, a first energy source which supplies electric energy to the primary brake control unit, and a second energy source which supplies electric energy to the secondary brake control unit. The electromechanical brake system further includes at least first and second electromechanical front axle brake actuators and at least first and second electromechanical rear axle brake actuators, which are actuatable by the primary brake control unit and the secondary brake control unit for implementing a braking request. Furthermore, the electromechanical brake system has a pneumatic trailer valve arrangement which is preferably formed according to one of the preferred embodiments of a pneumatic trailer valve arrangement described above according to the first aspect of the present disclosure. The trailer control valve of the trailer valve arrangement is connected to the primary brake control unit and receives trailer switching signals from the latter. The redundancy valve unit of the trailer valve arrangement is connected to the secondary brake control unit and receives redundancy switching signals from the latter.

It is to be understood that the pneumatic trailer valve arrangement according to the first aspect of the present disclosure and the electromechanical brake system according to the second aspect of the present disclosure have the same and similar sub-aspects as are set forth herein. In this respect, full reference is made to the above description.

In one variant, the redundancy valve unit includes a redundancy valve unit housing and is installed as an independent module in the brake system. Alternatively, the redundancy valve unit is integrated in the secondary brake control unit. Alternatively, the electromechanical brake system has an air treatment unit, wherein the redundancy valve unit is integrated in the air treatment unit.

The primary brake control unit and the secondary brake control unit are preferably conceived in such a manner that they can functionally provide at least redundancy. In particular, the secondary brake control unit serves as a backup control unit that assumes control of the electromechanical brake system in the event that the primary brake control unit does not function, or does not function correctly. It can also be provided that these conjointly assume control, for example that functions of the primary brake control unit would continue to be executed, while functions of the primary brake control unit that no longer function are replaced by the secondary brake control unit. This can be the case, for example, if the trailer control valve cannot be actuated, or can no longer be correctly electrically actuated. In this case, it is preferred that the secondary brake control unit actuates the redundancy valve unit in order to control the trailer brake pressure redundantly but purely pneumatically.

In a third aspect, the present disclosure achieves the object mentioned at the outset by a commercial vehicle having a front axle and at least one rear axle, and an electromechanical brake system according to one of the preferred embodiments of an electromechanical brake system described above according to the second aspect of the present disclosure. It is to be understood that the commercial vehicle according to the third aspect of the present disclosure and the electromechanical brake system according to the second aspect of the present disclosure have the same or similar sub-aspects as are set forth herein. In this respect, full reference is made to the above description on the first and second aspects of the present disclosure.

In a third aspect, the present disclosure achieves the object mentioned at the outset by a method for redundant braking of a trailer of a tractive unit-trailer rig, wherein the tractive unit has an electromechanical brake system, which is preferably designed according to one of the preferred embodiments of an electromechanical brake system described above according to the second aspect of the present disclosure, and the trailer has a pneumatic brake system. The procedure provides trailer switching signals to a trailer control valve from a primary brake control unit in an operational situation, and the trailer control valve controls trailer brake pressure at a trailer brake pressure connector depending on the trailer switching signals. In the event of a fault, in which the provision of the trailer switching signals is partially or completely prevented, a redundancy valve unit sets a pneumatic redundancy pressure at a redundancy connector of the trailer control valve, and the trailer control valve sets the trailer brake pressure redundantly as a function of the redundancy pressure at the trailer brake pressure connector.

Again, it is to be understood that the method according to the fourth aspect of the present disclosure, the pneumatic trailer valve arrangement according to the first aspect of the present disclosure, the electromechanical brake system according to the second aspect of the present disclosure and the commercial vehicle according to the third aspect of the present disclosure have the same and similar sub-aspects as are set forth herein. In this respect, full reference is also made to the above description for the preferred refinement of the method.

In a preferred embodiment of the method, it is provided that the redundancy valve unit receives redundancy switching signals from a secondary brake control unit, and sets a redundancy pressure as a function of redundancy switching signals.

Embodiments of the present disclosure will now be described hereunder with reference to the drawings. These are not necessarily to represent the embodiments to scale, but the drawings are embodied in a schematic and/or slightly distorted fashion if this facilitates the purpose of explanation. Reference is made to the relevant state of the art in respect of additions to the teachings immediately recognizable from the drawings. It is to be noted that a wide range of modifications and changes can be made regarding the shape and detail of an embodiment without departing from the general idea of the present disclosure. The features of the present disclosure disclosed in the description, drawings and claims may be relevant to the refinement of the present disclosure either individually or in any combination. Moreover, all combinations of at least two of the features disclosed in the description, drawings and/or claims fall within the scope of the present disclosure. The general idea of the present disclosure is not limited to the exact form or detail of the preferred embodiments shown and described below, or to a subject matter that would be restricted in comparison to the subject matter claimed in the claims. In the case of specified ranges of dimensions, values that are within the specified limits should also be disclosed as limit values and be used and claimed at will. For the sake of simplicity, the same reference signs are used below for identical or similar parts or parts with identical or similar functions.

Further advantages, features and details of the present disclosure are derived from the following description of the preferred embodiments, and by means of the drawings in which:

### BRIEF DESCRIPTION OF THE DRAWINGS

FIG. 1 shows a schematic illustration of an electromechanical brake system in a first exemplary embodiment;

FIG. 2 shows a schematic illustration of an electromechanical brake system in a second exemplary embodiment;

FIG. 3 shows a schematic illustration of an electromechanical brake system in a third exemplary embodiment;

FIG. 4 shows a schematic illustration of a pneumatic trailer valve arrangement in a first exemplary embodiment;

FIG. 5 shows a schematic illustration of a pneumatic trailer valve arrangement in a second exemplary embodiment; and

FIG. 6 shows a schematic illustration of a pneumatic trailer valve arrangement in a third exemplary embodiment.

### DETAILED DESCRIPTION

An electromechanical brake system 202 is provided for a commercial vehicle 200 which is designed here as a two-axle commercial vehicle 200 and has a front axle VA and a rear axle HA. It is to be understood that such commercial vehicles 200 can also have a second rear axle and can be designed overall as multi-axle vehicles. The electromechanical brake system 202 has a primary operating level 204 and a secondary redundancy level 206, which can handle the deceleration of the commercial vehicle 200 in the event that the operating level 204 does not function, or does not function correctly. The primary operating level 204 is fed by a first energy source 210 and includes a primary brake control unit 50. The primary brake control unit 50 is connected via a primary vehicle bus 212 to further units of the commercial vehicle 200, such as a unit for autonomous driving 222, so as to receive and implement from the latter trajectory data, braking requests or maneuvers. The electromechanical brake system 202 also includes a brake value transducer 208 which can be designed, for example, as an electric brake pedal. The brake value transducer 208 is connected to the primary brake control unit 50 in a manner fundamentally known. The primary brake control unit 50 is furthermore connected to first and second electromechanical front axle brake actuators 230a, 230b and first and second electromechanical rear axle brake actuators 232a, 232b and at those provides control signals SB1, SB2. In the secondary redundancy level 206, the electromechanical brake system 202 includes a secondary brake control unit 60, which can functionally at least partially substitute the primary brake control unit 50. The secondary brake control unit 60 assumes control of the electromechanical brake system 202 in the event that the primary brake control unit 60 does not function, or does not function correctly. The secondary brake control unit 60 is also connected to the brake value transducer 208 and receives signals from further units, such as in particular the unit for autonomous driving 222, via a secondary vehicle bus 214. The secondary brake control unit 60 is also connected to the first and second electromechanical front axle brake actuators 230a, 230b and the first and second electromechanical rear axle brake actuators 232a, 232b, and can provide those with redundant actuating signals SB3, SB4 in the event of a redundancy. For this purpose, the first and second electromechanical front axle brake actuators 230a, 230b and the first and second electromechanical rear axle brake actuators 232a, 232b are connected to both the first and the second energy source 210, 220.

The electromechanical brake system 202 is conceived to actuate a trailer (not shown). For this purpose, the electromechanical brake system 202 includes a pneumatic trailer valve arrangement 1, which makes it possible to control even conventional trailers with a purely pneumatically arranged trailer brake system. The pneumatic trailer valve arrangement 1 includes a trailer control valve 10, which can basically be designed in a known manner. The trailer control valve 10 has a trailer supply connector 12 (“red coupling head” or “supply coupling head”) by way of which a supply pressure pV can be transmitted to the trailer. Moreover, the trailer control valve 10 has a trailer brake pressure connector 14 (“yellow coupling head” or “brake coupling head”) by way of which a trailer brake pressure pBA can be transmitted to the trailer. The trailer brake pressure pBA is a control pressure that indicates the amount of brake pressure set at trailer brake actuators in the trailer.

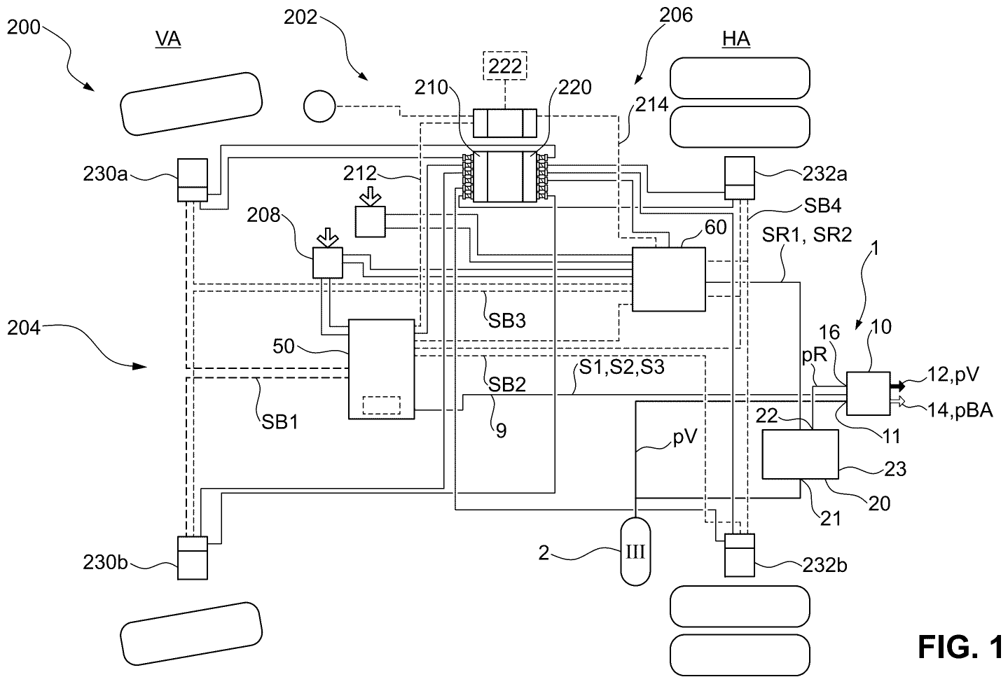

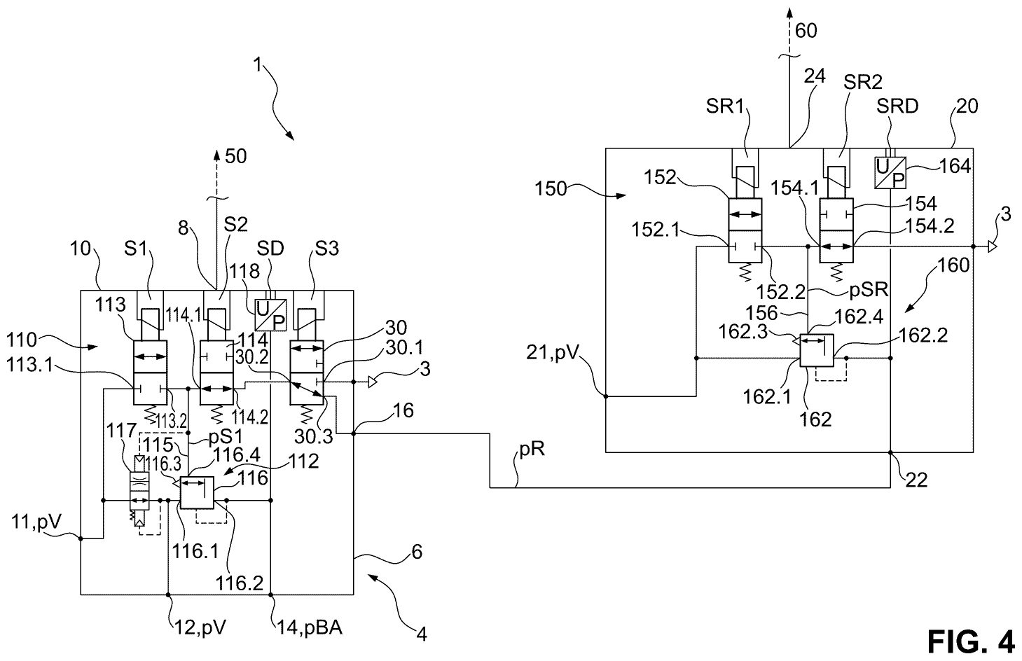

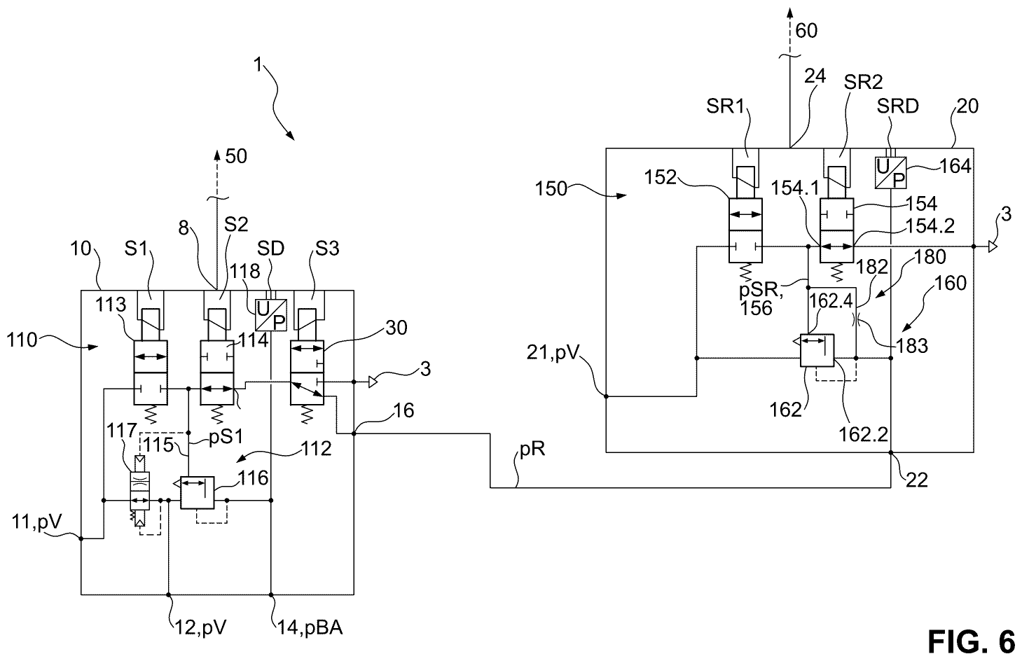

The trailer control valve 10 also has a supply connector 11 via which the trailer control valve 10 receives a supply pressure pV from a compressed air supply 2 provided for this purpose. The trailer control valve 10 has various electromagnetic valves, as will yet be described below with reference to FIGS. 4 to 6. For switching these electromagnetic valves, the trailer control valve 10 is connected to the primary brake control unit 50 via an electrical line 9 and receives from this trailer switching signals S1, S2, S3. In the embodiment shown here (FIG. 1), the trailer control valve 10 does not have its own intelligence; instead, the electromagnetic valves (see FIG. 6 below) are switched directly by the primary brake control unit 50. In other embodiments, it can also be provided that the trailer control valve 10 has its own intelligence and, to this extent, braking requests, trajectory data or other requirements are transferred from the primary brake control unit 50 or via the primary or secondary vehicle bus 212, 214, which are then independently implemented by the trailer control valve 10 in order to in this way set the trailer brake pressure pBA.

An electrical connection between the secondary brake control unit 60 and the trailer control valve 10 is not provided directly, but could be provided in a way analogous to the electrical line 9, in the event that the secondary brake control unit 60 is also to directly control and switch the trailer control valve 10 in redundancy operation. In the exemplary embodiment shown here (FIG. 1), a pneumatic actuation of the trailer brake pressure pBA is specifically provided for the redundancy operation. For this purpose, the pneumatic trailer valve arrangement 1 has a redundancy valve unit 20. The redundancy valve unit 20 also has electromagnetic valves, as will yet be explained in more detail below with reference to FIGS. 4 to 6. The redundancy valve unit 20 is connected to the secondary brake control unit 60 and receives redundancy switching signals SR1, SR2 from the latter. In other embodiments, the redundancy switching signals SR1, SR2 can also be provided by the primary brake control unit 50 or another superordinate control unit. It can also be provided that the redundancy valve unit 20 has its own intelligence and can therefore also be connected to the primary and/or secondary vehicle bus 212, 214. The redundancy valve unit 20 has a supply connector 21 which is presently also connected to the compressed air supply 2. In other embodiments, it can also be provided that a separate dedicated compressed air supply for the redundancy valve unit 20 is provided, or that the latter is directly connected to a compressor. The redundancy valve unit 20 has a redundancy output 22 for providing a redundancy pressure pR, which is set as a function of the received redundancy switching signals SR1, SR2. The redundancy output 22 is connected exclusively to a redundancy connector 16 of the trailer control valve 10 that receives the redundancy pressure pR from the redundancy valve unit 20. The trailer control valve 10 is designed to receive and implement the redundancy pressure PR in order to set the trailer brake pressure pBA based on this.

In the exemplary embodiment shown here (FIG. 1), the redundancy valve unit 20 includes a dedicated redundancy valve unit housing 23 and is provided as a separate module in the electromechanical brake system 202. In particular, an existing and already available trailer control valve 10, as it is available from known pneumatic brake systems, can be implemented in the electromechanical brake system 202 and controlled via the redundancy valve unit 20 as a result.

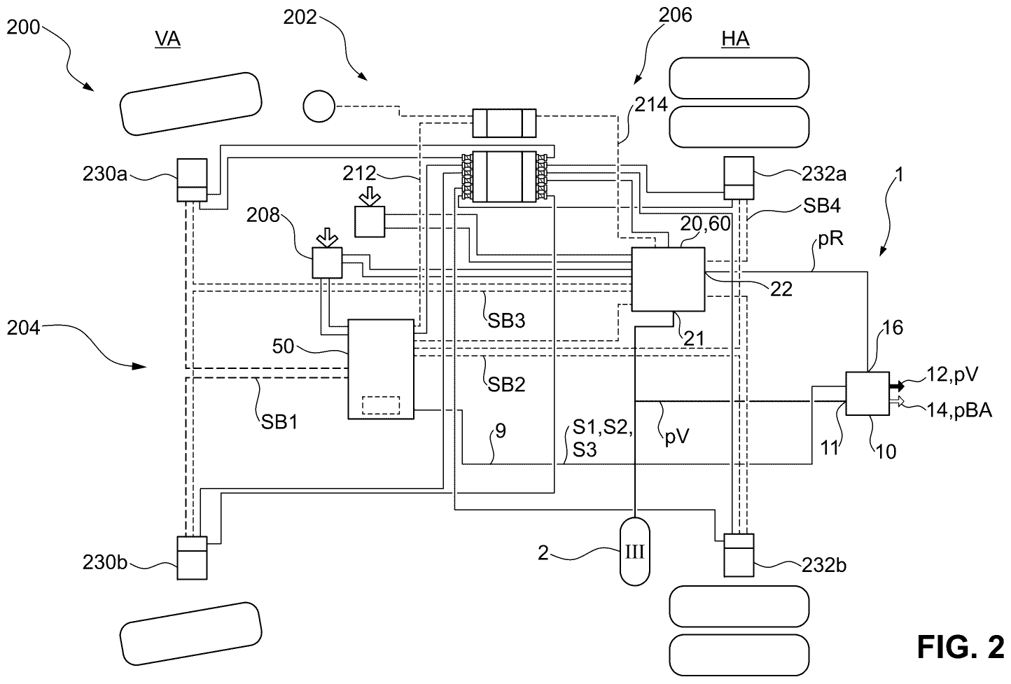

FIG. 2 shows the electromechanical brake system 202 in a second exemplary embodiment. Identical and similar elements are provided with the same reference signs as in the first exemplary embodiment (FIG. 1), so that full reference is made to the above description to the first exemplary embodiment (FIG. 1). In particular, the differences in comparison to the first exemplary embodiment are highlighted below, while commonalities are not discussed in detail.

The main difference between the first exemplary embodiment (FIG. 1) and the second exemplary embodiment (FIG. 2) lies in that the redundancy valve unit 20 is integrated in the secondary brake control unit 60. The redundancy valve unit 20 therefore does not require its own redundancy valve unit housing 23, but is part of the secondary brake control unit 60.

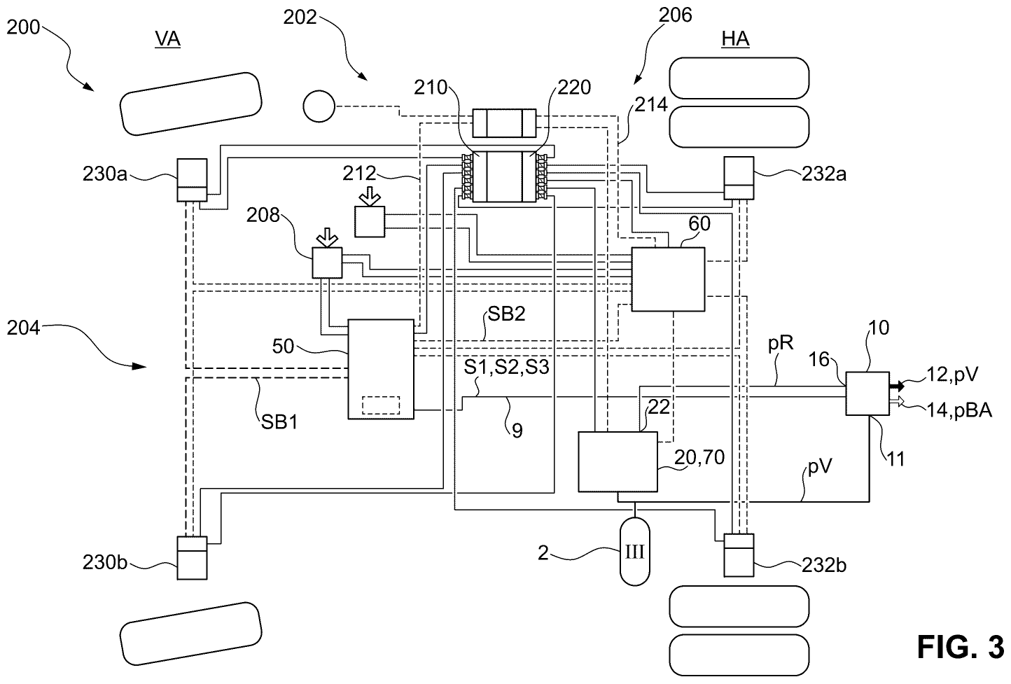

FIG. 3 shows a third exemplary embodiment of the electromechanical brake system 202, and in turn identical and similar elements are provided with the same reference signs as in the first two exemplary embodiments. In this respect, differences are again essentially highlighted, while commonalities are not discussed in detail.

The main difference in comparison to the first two exemplary embodiments (FIG. 1, FIG. 2) lies in that the electromechanical brake system 202 in the third exemplary embodiment (FIG. 3) has an electronic air treatment unit 70. The electronic air treatment unit 70 is connected to the second energy source 220, but can alternatively or additionally also be connected to the first energy source 210. Furthermore, said electronic air treatment unit 70 is connected to the secondary vehicle bus 214, but can additionally or alternatively also be connected to the primary vehicle bus 212. The electronic air treatment unit 70 is also connected to the compressed air supply 2 and supplies the latter with compressed air to provide the supply pressure pV. In the exemplary embodiment shown here, the redundancy valve unit 20 is integrated in the air treatment unit 70. However, it is to be understood that the redundancy valve unit 20 as shown in the first or second exemplary embodiment (FIG. 1, FIG. 2) can also be formed in electromechanical brake systems 202 with an air treatment unit 70. The integration of the redundancy valve unit 20 in the air treatment unit 70 can lead to a reduced footprint of the electromechanical brake system 202 and to the elimination of electrical and/or pneumatic lines.

FIGS. 4 to 6 now show three different exemplary embodiments of the pneumatic trailer valve arrangement 1, wherein the internal circuit diagram is illustrated.

With reference to FIG. 4 on the left side, the trailer control valve 10 is shown first, which is designed here as a trailer control module 4 having a trailer control module housing 6. The trailer control valve 10 includes an electrical connector 8 by way of which the trailer control valve 10 is connected to the primary brake control unit 50 and receives from the latter the first, the second and the third trailer switching signals S1, S2, S3. In addition to the connectors already described, specifically the supply connector 11 for receiving supply pressure pV, which is connected to the compressed air supply 2, the trailer supply connector 12, the trailer brake pressure connector 14 and the redundancy connector 16, the trailer control valve 10 also includes a bleeding unit 3 which in the customary manner bleeds into the environment, optionally by way of an intervening silencer.

Internally, the trailer control valve 10 in a fundamentally known manner includes a pilot control unit 110 and a main valve unit 112. The pilot control unit 110 provides a first control pressure pS1 to the main valve unit 112 which sets the trailer brake pressure pBA based on the reception of the first control pressure pS1.

For this purpose, the pilot control unit 110 includes an inlet valve 113 and an outlet valve 114, each presently configured as 2/2-way valves. The inlet valve 113 and the outlet valve 114 can also be combined as a single 3/2-way valve, which can then be referred to as an inlet/outlet valve. The inlet valve 113 has a first inlet valve connector 113.1 which is connected to the supply connector 11 and receives a supply pressure. A second inlet valve connector 113.2 is connected to a control pressure line 115 into which the first control pressure pS1 is inputted. The inlet valve 113 is designed to be monostable and de-energized in the first closed switching position shown in FIG. 4. By providing the first switching signal S1, the inlet valve 113 can be moved to the second switching position not shown in FIG. 4, in which the first and the second inlet valve connector 113.1, 113.2 are in connection. The first control pressure pS1 is set in the second, energized switching position. The outlet valve 114 serves to bleed the first control pressure pS1 or the control pressure line 115. The outlet valve 114 is also designed as a 2/2-way valve and has a first outlet valve connector 114.1 which is connected to the control pressure line 115, and a second outlet valve connector 114.2, which is connected, or connectable, to the bleeding unit 3, in the embodiment shown here via a redundancy check valve 30 which will be described below. The outlet valve 114 is monostable and de-energized in the first open switching position shown in FIG. 4, and can be moved to the closed switching position not shown in FIG. 4 by providing the second switching signal S2.

The main valve unit 112 includes a relay valve 116 having a relay valve supply connector 116.1 which is connected or connectable to the supply connector 11, a relay valve working connector 116.2, which is connected to the trailer brake pressure connector 14 and sets the trailer brake pressure pBA, a relay valve bleeding connector 116.3 which is connected to a or the bleeding unit 3, and a relay valve control connector 116.4 which is connected to the control pressure line 15 and receives the first control pressure pS1. The relay valve 116 serves to receive and boost the first control pressure pS1, and to set the boosted pressure as the trailer brake pressure pBA at the trailer brake pressure connector 14.

The relay valve 116 is preceded by a breakaway safety valve 117, which ensures that the relay valve 116 is no longer supplied with supply pressure pPV when the trailer is disconnected from the tractive unit.

In order to detect the set trailer brake pressure pBA, the trailer control valve 10 also includes a pressure sensor 118 which can provide a pressure signal SD to the primary brake control unit 50.

As already mentioned above, the trailer control valve 10 also includes a redundancy check valve 30 which serves to block or release the redundancy connector 16 of the trailer control valve 10. The redundancy pressure pR is received by the redundancy valve unit 20 at the redundancy connector 16. According to the exemplary embodiment shown here, the redundancy pressure pR is input via the bleeding path of the trailer control valve 10 and can be set via the redundancy check valve 30 and the opened outlet valve 114 and input into the control pressure line 115 and thus be provided at the relay valve control connector 116.4. In this way, the relay valve 116 can then set the trailer brake pressure pBA based on the redundancy pressure pR. In other variants it can also be provided that the redundancy pressure pR is provided directly as a volumetric pressure and is able to be set without boosting by the relay valve 116 at the trailer brake pressure connector 14.

The redundancy check valve 30 is designed here as an electromagnetic 3/2-way valve and has a first redundancy check valve connector 30.1 which is connected to the bleeding unit 3, a second redundancy check valve connector 30.2 which is connected to the outlet valve 114, more specifically the second outlet valve connector 114.2, and a third redundancy check valve connector 30.3 which is connected to the redundancy connector 16. The redundancy check valve 30 is monostable and in a first de-energized switching position connects the third redundancy check valve connector 30.3 to the second redundancy check valve connector 30.2, so that the redundancy pressure pR can be set when de-energized. When energized, the redundancy check valve 30 switches to the second switching position not shown in FIG. 4, and connects the first redundancy check valve connector 30.1 to the second redundancy check valve connector 30.2, so that the outlet valve 114 is connected to the bleeding unit 3. In the normal operation of the commercial vehicle 200, the third switching signal S3 should be provided in order to cause a lockout of the redundancy pressure pR and to allow the first control pressure pS1 to be bled via the bleeding unit 3. In the event of a fault, when the first, the second and the third switching signals S1, S2, S3 can no longer be provided, the inlet valve 113, the outlet valve 114 and the redundancy check valve 30 are each in the switching positions shown in FIG. 4, so that the redundancy pressure pR can be provided at the relay valve 116 by the redundancy check valve 30 and the outlet valve 114.

The redundancy valve unit 20 is shown schematically here and it is to be understood that this can be designed, as shown in FIG. 1, as an independent unit having a redundancy valve unit housing 23, and likewise be integrated in another unit, as illustrated in FIGS. 2 and 3. In this respect, FIGS. 4 to 6 are to be understood only schematically. It is also conceivable that the redundancy valve unit 20 is integrated with the trailer control valve 10.

In the exemplary embodiment illustrated here, the redundancy valve unit 20 includes a redundancy pilot control unit 150 and a redundancy main valve unit 160. In other embodiments, it can also be provided that a separation between the redundancy pilot control unit and the redundancy main valve unit is not provided, but only directly switched valves are provided. The redundancy pilot control unit 150 and the redundancy main valve unit 160 are designed in a manner similar to the pilot control unit 110 and the main valve unit 112 of the trailer control valve 10. The redundancy pilot control unit 150 has an inlet valve 152 and an outlet valve 154. The inlet valve 152 is designed as a 2/2-way valve and has a first inlet valve connector 152.1 which is connected to the supply connector 21 of the redundancy valve unit 20 and receives supply pressure pV. A second inlet valve connector 152.2 is connected to a redundancy control pressure line 156 and sets the redundancy control pressure pSR and inputs this into the latter. The inlet valve 152 is designed to be monostable and de-energized in the first switching position shown in FIG. 4, in which the first and the second inlet valve connector 152.1, 152.2 are disconnected. The outlet valve 154 is also designed as a 2/2-way valve and has a first outlet valve connector 154.1 and a second outlet valve connector 154.2, wherein the first outlet valve connector 154.1 is connected to the redundancy control pressure line 156 and the second outlet valve connector 154.2 is connected to the bleeding unit 3.

The redundancy valve unit 20 has an electrical redundancy valve unit connector 24, via which the redundancy valve unit 20 is connected to the secondary brake control unit 60 and receives the first and the second redundancy switching signals SR1, SR2 from the latter. The inlet valve 152 can be switched by the first redundancy switching signal SR1, and the outlet valve 154 can be switched by the second redundancy switching signal SR2.

The redundancy main valve unit 160 includes a redundancy relay valve 162 having a redundancy relay valve supply connector 162.1 which is connected to the supply connector 21, a redundancy relay valve working connector 162.2 which is connected to the redundancy output 22 and provides the redundancy pressure pR at the latter, a redundancy relay valve bleeding connector 162.3 as well as a redundancy relay valve control connector 162.4 which is connected to the redundancy control pressure line 156 and receives the redundancy control pressure pSR. The redundancy relay valve 162 boosts the redundancy control pressure pSR and then sets the latter as redundancy pressure pR at the redundancy output 22. In order to detect the set redundancy pressure pR, the redundancy valve unit 20 also includes a redundancy pressure sensor 164 which can provide a redundancy pressure signal SRD at the secondary brake control unit 60.

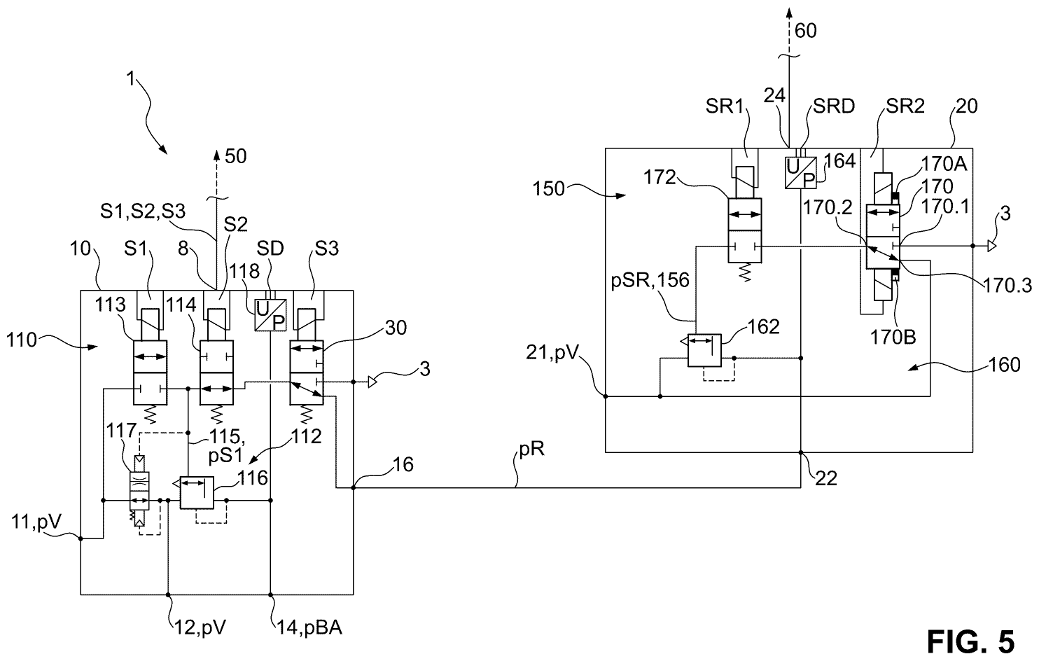

FIG. 5 shows a second exemplary embodiment of the pneumatic trailer valve arrangement 1, and identical and similar elements are illustrated with the same reference signs as in the first exemplary embodiment according to FIG. 4. In the following, the differences in comparison to the embodiment according to FIG. 4 are emphasized in particular, while commonalities are substantially not discussed.

The differences here are in the design of the redundancy valve unit 20, more specifically in the design of the redundancy pilot control unit 150; the redundancy main valve unit 160 is identical to the redundancy valve unit 160 according to the exemplary embodiment shown in FIG. 4.

In contrast to the exemplary embodiment shown in FIG. 4, the redundancy pilot control unit 150 is bistable in the exemplary embodiment illustrated in FIG. 5. For this purpose, the redundancy pilot control unit 150 has an electromagnetic bistable valve 170. The electromagnetic bistable valve 170 is designed as a 3/2-way valve and has two stable latching positions. It has a first bistable valve connector 170.1 which is connected to the bleeding unit 3, a second bistable valve connector 170.2 which is connected or connectable to the redundancy main valve unit 160, and a third bistable valve connector 170.3, which is connected to the supply connector 21 and receives supply pressure pV. The bistable valve 170 can be switched based on the second redundancy switching signal SR2, and has a first magnet 170a and a second magnet 170b to provide the two stable latching positions. In the first switching position not shown in FIG. 5, the first bistable valve connector 170.1 is connected to the second bistable valve connector 170.2 so that the redundancy control pressure line 156 can be bled. In the second switching position shown in FIG. 5, the third bistable valve connector 170.3 is connected to the second bistable valve connector 170.2 so that the redundancy control pressure line 156 can be bled. A holding valve 172, which is designed as a 2/2-way valve, is also inserted here between the bistable valve 170 and the redundancy main valve unit 160. In the open position, in which it is pre-loaded in a monostable manner and which is shown in FIG. 5, the redundancy control pressure pSR can be both set and bled. In the second switching position of the holding valve 172 not shown in FIG. 5, a pressure set at the redundancy main valve unit 160 can be captured.

Such bistability is particularly preferred if the trailer is to be braked permanently, for example, if the vehicle rig is to be securely parked in the event of a fault.

FIG. 6 now shows a third variant of the pneumatic trailer valve arrangement 1, which in turn has a bistability in the redundancy valve unit 20. Again, identical and similar elements are provided with the same reference signs as in the previous description, so that full reference is made to the above description. In the following, the differences in comparison to the first and the second exemplary embodiment of the pneumatic trailer valve arrangement 1, as shown in FIGS. 4 and 5, are emphasized in particular. The third exemplary embodiment of the pneumatic trailer valve arrangement 1 is based on the first exemplary embodiment of the pneumatic trailer valve arrangement 1, but includes self-locking, in this case pneumatic self-locking 180. The pneumatic self-locking 180 is designed in such a way that it includes a return line 182 having a throttle 183 which connects the redundancy relay valve working connector 162.2 to the redundancy relay valve control connector 162.4. This means, that the redundancy pressure pR, which is set at the redundancy relay valve working connector 162.2, is returned in a throttled manner and provided at the redundancy relay valve control connector 162.4, as a result of which pneumatic self-locking is achieved. Even if the outlet valve 154 is moved to the bleeding position not shown in FIG. 6, in which the first outlet valve connector 154.1 is connected to the second outlet valve connector 154.2, the self-locking can be maintained by virtue of the throttle. For this reason, the inlet valve 152 can also assume a different monostable position than the inlet valve 152 according to the first exemplary embodiment (FIG. 4). A permanent readjustment of supply pressure via the inlet valve is not necessary to maintain the redundancy pressure pR.

### LIST OF REFERENCE SIGNS (PART OF THE DESCRIPTION)

1 Pneumatic trailer valve arrangement
2 Compressed air supply
3 Bleeding unit
4 Trailer control module
6 Trailer control module housing
8 Electrical termination
9 Electrical line
10 Trailer control valve
11 Supply connector of the trailer control valve
12 Trailer supply connector
14 Trailer brake pressure connector
16 Redundancy connector
20 Redundancy valve unit
21 Supply connector of the redundancy valve unit
22 Redundancy output
23 Redundancy valve unit housing
24 Electrical redundancy valve unit connector
30 Redundancy check valve
30.1 First redundancy check valve connector
30.2 Second redundancy check valve connector
30.3 Third redundancy check valve connector
50 Primary brake control unit
60 Secondary brake control unit
70 Air treatment unit
110 Pilot control unit
112 Main valve unit
113 Inlet valve
113.1 First inlet valve connector
113.2 Second inlet valve connector
114 Outlet valve
114.1 First outlet valve connector
114.2 Second outlet valve connector
115 Control pressure line
116 Relay valve
116.1 Relay valve supply connector
116.2 Relay valve working connector
116.3 Relay valve bleeding connector
116.2 Relay valve control connector
117 Breakaway safety valve
118 Pressure sensor
150 Redundancy pilot control unit
152 Inlet valve
152.1 First inlet valve connector
152.2 Second inlet valve connector
154 Outlet valve
154.1 First outlet valve connector
154.2 Second outlet valve connector
156 Redundancy control pressure line
160 Redundancy main valve unit
162 Redundancy relay valve
162.1 Redundancy relay valve supply connector
162.2 Redundancy relay valve working connector
162.3 Redundancy relay valve bleeding connector
162.4 Redundancy relay valve control connector
164 Redundancy pressure sensor
170 Electromagnetic bistable valve
172 Holding valve
180 Pneumatic self-locking
182 Return line
183 Throttle
200 Commercial vehicle
202 Brake system
204 Primary operational level
206 Secondary redundancy level
208 Brake value transducer
210 First energy source
212 Primary vehicle bus
214 Secondary vehicle bus
220 Second energy source
222 Autonomous driving unit
230a, 230b First and second electromechanical front axle brake actuators
232a, 232b First and second electromechanical rear axle brake actuators
pBA Trailer brake pressure
pR Redundancy pressure
PS1 First control pressure
pSR Redundancy control pressure
pV Supply pressure
S1 First trailer switching signal
S2 Second trailer switching signal
S3 Third trailer switching signal
SB1-SB4 First to fourth actuating signals
SD Pressure signal
SR1 First redundancy switching signal
SR2 Second redundancy switching signal
SRD Redundancy pressure signal
VA Front axle
HA Rear axle

1. A pneumatic trailer valve arrangement (1) for a brake system (202), comprising
a trailer control valve (10) having a supply connector (11) for receiving supply pressure (pV), a trailer supply connector (12) for providing supply pressure (pV) for a trailer, a trailer brake pressure connector (14) for providing a trailer brake pressure (pBA) for the trailer, an electromagnetic pilot control unit (110) which, as a function of trailer switching signals (S1, S2, S3) received at the trailer control valve (10), sets the trailer brake pressure (pBA) at the trailer brake pressure connector (12), and having a pneumatic redundancy connector (16) for receiving a redundancy pressure (pR);
wherein the trailer control valve (10), in the absence of the trailer switching signals (S1, S2, S3), sets the trailer brake pressure (pBA) redundantly as a function of the redundancy pressure (pR) at the trailer brake pressure connector (14);
a redundancy valve unit (20) having a supply connector (21) for receiving supply pressure (pV), and a redundancy output (22) for providing the redundancy pressure (pR), wherein the redundancy valve unit (20) provides the redundancy pressure (pR) at the redundancy output (22) as a function of the redundancy switching signals (SR1, SR2) received at the redundancy valve unit (20).

2. The pneumatic trailer valve arrangement (1) as claimed in claim 1, wherein the redundancy connector (16) is connected to the pilot control unit (110).

3. The pneumatic trailer valve arrangement (1) as claimed in claim 1, wherein the trailer control valve (10) has a redundancy check valve (30) for blocking the redundancy connector (16).

4. The pneumatic trailer valve arrangement (1) as claimed in claim 1, wherein the trailer switching signals (S1, S2, S3) and the redundancy switching signals (SR1, SR2) are provided by two independent and at least partially redundant electronic control units (50, 60).

5. The pneumatic trailer valve arrangement (1) as claimed in claim 1, wherein the redundancy valve unit (20) has a redundancy valve unit housing (23) and can be installed as an independent module in the brake system (202).

6. The pneumatic trailer valve arrangement (1) as claimed in claim 1, wherein the redundancy valve unit (20) is integrated in a further functional module of the brake system (202).

7. The pneumatic trailer valve arrangement (1) as claimed in claim 6, wherein the further module is a primary brake control unit (50), a secondary brake control unit (60), or an air treatment unit (70).

8. The pneumatic trailer valve arrangement (1) as claimed in claim 1, wherein the redundancy valve unit (20) has an electromagnetic redundancy pilot control unit (150) and a redundancy main valve unit (160), wherein the redundancy pilot control unit (150) sets a redundancy control pressure (pSR) at the redundancy main valve unit (160) based on the redundancy switching signals (SR1, SR2), and the redundancy main valve unit (160) sets the redundancy pressure (pR) based on the redundancy control pressure (pSR).

9. The pneumatic trailer valve arrangement (1) as claimed in claim 8, wherein the redundancy pilot control unit (150) has an inlet valve (152) and an outlet valve (154), wherein the inlet valve (152) is connected to the supply connector (21), receives a supply pressure (pV) and is able to be switched by a first redundancy switching signal (SR1) to set the redundancy control pressure (pSR) at the redundancy main valve unit (160), and wherein the outlet valve (154) is connected to a bleeding unit (3) and is able to be switched by a second redundancy signal (SR2) to bleed the redundancy control pressure (pSR).

10. The pneumatic trailer valve arrangement (1) as claimed in claim 1, wherein the redundancy valve unit (20) is bistable, so that a set redundancy pressure (pR) remains set when the redundancy switching signals (SR1, SR2) are absent.

11. The pneumatic trailer valve arrangement (1) as claimed in claim 10, wherein the redundancy valve unit includes an electromagnetic bistable valve (170).

12. The pneumatic trailer valve arrangement (1) as claimed in claim 10, wherein the redundancy valve unit is bistable via pneumatic self-locking (180), and includes a return line having a throttle that connects a working connector of a redundancy relay valve (162) to a control connector of the redundancy relay valve (162), such that the redundancy pressure is returned in a throttled manner and provided at the control connector.

13. An electromechanical brake system (202) for a commercial vehicle, comprising:
a primary brake control unit (50) and a secondary brake control unit (60), a first energy source (210) which supplies electric energy to the primary brake control unit (50), and a second energy source (220) which supplies electric energy to the secondary brake control unit (60);
at least first and second electromechanical front axle brake actuators (230a, 230b) and at least first and second electromechanical rear axle brake actuators (232a, 232b), which are actuatable by the primary brake control unit (50) and the secondary brake control unit (60) for implementing a braking request; and
a pneumatic trailer valve arrangement (1) as claimed in claim 1, wherein the trailer control valve (10) is connected to the primary brake control unit (50) and receives trailer switching signals (S1, S2, S3) from the primary brake control unit, and the redundancy valve unit (20) is connected to the secondary brake control unit (60) and receives redundancy switching signals (SR1, SR2) from the secondary brake control unit.

14. The electromechanical brake system (202) as claimed in claim 13, wherein the redundancy valve unit (20) includes has a redundancy valve unit housing and is installed as an independent module in the brake system (202).

15. The electromechanical brake system (202) as claimed in claim 13, wherein the redundancy valve unit (20) is integrated into the secondary brake control unit (60).

16. The electromechanical brake system (202) as claimed in claim 13, having an air treatment unit (70), wherein the redundancy valve unit (20) is integrated into the air treatment unit (70).

17. A commercial vehicle (200) having a front axle (VA) and at least one rear axle (HA), and the electromechanical brake system (202) as claimed in claim 13.

18. A method for the redundant braking of a trailer of a tractive unit-trailer rig, wherein the tractive unit includes electromechanical brake system (202), and the trailer has a pneumatic brake system, wherein
in a first operational state, a trailer control valve (10) is provided with trailer switching signals (S1, S2, S3) by a primary brake control unit (60), and the trailer control valve (10) sets a trailer brake pressure (pBA) at a trailer brake pressure connector (14) based on the trailer switching signals (S1, S2, S3); and
in a second operation state during a fault, in which the provision of the trailer switching signals (S1, S2, S3) is partially or completely prevented, a redundancy valve unit (20) sets a pneumatic redundancy pressure (pR) at a redundancy connector (16) of the trailer control valve (10), and the trailer control valve (10) sets the trailer brake pressure (pBA) redundantly based on the redundancy pressure (pR) at the trailer brake pressure connector (14).

19. The method as claimed in claim 18, wherein the redundancy valve unit (20) receives redundancy switching signals (SR1, SR2) from a secondary brake control unit (60), and sets the redundancy pressure (pR) based on the redundancy switching signals (SR1, SR2).

20. The pneumatic trailer valve arrangement (1) as claimed in claim 1, wherein the redundancy valve unit includes a redundancy relay valve having a pneumatic control connector, at which the redundancy pressure (pR) is set, wherein the redundancy relay valve boosts the redundancy pressure (pR) and provides the boosted redundancy pressure (pR) the redundancy output
